(19) United States
(12) Patent Application Publication
(10) Pub. No.: US 2002/0156877 A1
(43) Pub. Date: Oct. 24, 2002

(54) System and method for the duplication of a software system onto an appropriate target computer

(76) Inventors: James C. Lu, Andover, MA (US); Robert B. McCown, Concord, MA (US); Ajay Pydah, Burlington, MA (US); Ganesh Rangarajan, Westwood, MA (US)

Correspondence Address: CESARI AND MCKENNA, LLP, 88 BLACK FALCON AVENUE, BOSTON, MA, 02210, US

(21) Appl. No.: 09/840,658

(22) Filed: Apr. 23, 2001

(51) Int. Cl. G06F 15/177; G06F 9/445

(52) U.S. Cl. 709/221; 717/178

(57) ABSTRACT

A system and method for duplicating the software system of a source computer and installing the duplicated software system on a plurality of target computers. A source computer is selected and an image of the software system and the hardware configuration of the source computer is made. A plurality of target computers that are hardware compatible with the source computer are selected for installation of a copy of the software system of the source computer. The software system of the source computer is duplicated based on information stored in the image of the source computer. The duplicated software system is then installed on each of the selected target computer systems.

### BACKGROUND OF THE INVENTION

1. Field of the Invention

The present invention relates generally to installing software on computer systems, and more specifically, to a system and method for duplicating a software system and installing that software system on a target computer.

2. Background Information

Over the years, the number of operating systems and software applications/packages that run on various hardware platforms has dramatically increased. Software companies have built very complex software that runs on multiple physical hardware boxes that communicate with each other. This assortment of software includes various operating systems, as well as applications such as database systems, accounting systems, word processors and spreadsheets.

Some of this software may be installed and run from a client computer such as the Personal Computer (PC). Other software may be centrally hosted by a Server and used by a number of Clients. For example, a typical “Web” application may have various pieces of software installed across many components such as a web server, an application server, and a database. In aggregate, these components typically comprise the Server. In a “Web” application environment, Clients would log into this Server through the Internet and run the various applications that are provided by the Server.

While it is good that a user has a wide choice of software to choose from, this increase in the number of choices has created a number of problems for administrators who are responsible for installing software on any number of computer systems.

For instance, administrators who manage the installation of software on a large number of computer systems often must keep track of each computer system's hardware configuration to ensure that the hardware configuration is adequate to support the software that is to be installed. Keeping track of this information may become quite involved, depending on the number of computer systems being managed. One way to manage the complexities of keeping track of this information is to create a database. However, creating and maintaining a database is often arduous and time-consuming and may be a waste of valuable IT resources in particular situations.

Another problem administrators often face is the task of manually installing software on a system, either remotely or locally. Methods that are often used to install software include:

Install the operating system, then install the software packages and applications individually;

Install the operating system, then use the application specific installation setup routines to install the applications from a shared network drive;

Install the operating system, then copy the application software over a network, using a file copy program such as File Transfer Protocol (FTP), and install the application software from a remote location;

Use local tools to capture an operating system and applications image locally and then “push” the image to the computer system where the image is to be installed;

Install the operating system and use a third party vendor product to push the application software to the computer system where the application software is to be installed.

As can be seen, these methods require a great deal of manual intervention on the part of the administrator and thus are often time-consuming and error prone. The magnitude of these problems greatly increase if a large number of computer systems are to be managed.

With the arrival of the Internet, as well as with global diversification of enterprises, the remote installation and management of a software system has become even more complex. Enterprises are constantly struggling to offer standardized software environments; yet it is not possible to do so within a distributed enterprise easily.

It is therefore desirable to provide a system that can capture the hardware and software configuration of a source computer system, create an image based on this captured information, determine what target systems can support the image, and install and configure that image on those target systems, automatically.

### SUMMARY OF THE INVENTION

A software system is defined as any combination of software that includes, but is not limited to, operating systems, applications and data files.

Network connectivity is defined as a connection that enables communication between entities, such as but not limited to, a connection that enables communication between computer systems. This connection may be of any form of communication medium including, but not limited to, point-to-point hardwired connections, wireless connections, and networked connections, among others.

An imaging area is defined as an area on a storage subsystem that contains an exact duplicate of the local disks of a source computer, script files, and operating-system-specific information.

The present invention relates to a system and method for duplicating the software system of a source computer system and installing this duplicated software system onto a plurality of target computer systems.

In the preferred illustrative embodiment of the invention, the system described is comprised of two major components, a Sending Node (SN) component and a Receiving Node (RN) component.

The Sending Node component comprises a deployment console, an imaging and packaging server (IPS), a storage subsystem, and a source computer system. The Receiving Node component comprises an intelligent installation server (IIS), a storage subsystem, and a plurality of target computer systems.

A packaging engine is a subset of the Sending Node. A packaging engine comprises the IPS and the storage subsystem of the Sending Node. An installation engine is a subset of the Receiving Node. An installation engine comprises the IIS and the storage subsystem of the Receiving Node.

The deployment console provides a user interface to the overall software duplication and installation process. From the deployment console, a user can select a source computer system, create an image of that source computer system, deploy that image to an installation engine, select a plurality of target computer systems associated with the installation engine and direct the installation engine to install a copy of the software system, represented in the deployed image, onto each of the selected target computer systems.

The imaging and packaging server (IPS) is essentially the central controlling point of the Sending Node component. The IPS basically creates images of source computer systems and deploys those images to the Receiving Node component. It interfaces with the deployment console, the storage subsystem at the Sending Node, and the intelligent installation server (IIS) at the Receiving Node.

The storage subsystem at the Sending Node provides data storage and retrieval for the IPS.

The source computer system is the computer system whose software system is to be installed on the target computer systems.

The IIS is the central controlling point on the Receiving Node. The IIS basically duplicates the source computer system's software at the Receiving Node and aids in the installation of this software system on the selected target computers. The IIS interfaces to the IPS, the storage subsystem on the Receiving Node and a plurality of target computer systems.

The storage subsystem at the Receiving Node provides data storage and retrieval for the IIS and the target computer systems.

The target computer systems are those computer systems that are to install a copy of source computer's software system.

In accordance with the preferred illustrative embodiment of the present invention, the method for duplicating the software system of a source computer system onto a target computer system as employed by the present invention can be summarized as follows.

At the deployment console, the user selects the source computer whose software system is to ultimately be duplicated onto a target computer. The IPS creates an image of the source computer system and saves it in its local storage subsystem.

Later, the user selects the image, as well as one or more Receiving Nodes that are to receive the image, and directs the IPS to deploy the image to the Receiving Nodes. At each Receiving Node, the IIS compiles a list of all target computers known to the Receiving Node that are hardware compatible with the source computer system and sends this list to the IPS for display on the deployment console.

From this list, the user selects the target computers that are to install a copy of the source computer's software system.

The IPS notifies the IIS of the user's selection. The IIS gathers the files that make up the source computer's software system and builds an image of this system in an imaging area on the IIS's storage subsystem. The IIS compresses and archives the imaging area along with script files, that are used to configure the software on the target computer, into an archive file. The IIS sends this archive file to the target computer. The target computer then installs the software system contained in the archive file.

When a target computer has completed its installation and has booted and configured the new software, it notifies the IIS that it has completed the installation. The IIS in turn notifies the IPS that the installation has completed. The IPS sends the completed status to the deployment console for display.

### BRIEF DESCRIPTION OF THE DRAWINGS

The detailed description of the preferred illustrative embodiment of the invention below refers to the accompanying drawings, of which:

FIG. 1 is a block diagram of a system that may advantageously be used to implement the preferred illustrative embodiment;

FIG. 2 is a detailed block diagram of the process of creating an image of a source computer;

FIG. 3 is a detailed block diagram of the process of choosing a target computer system;

FIG. 4 is a detailed block diagram of the process of creating an image of the source computer at a Receiving Node; and

FIG. 5 is a detailed block diagram of the process of installing an image on a target computer.

### DETAILED DESCRIPTION OF AN ILLUSTRATIVE EMBODIMENT

In accordance with the practices of persons skilled in the art of computer programming, certain aspects of the present invention are described as a method that can be implemented in the form of computer readable and executable program code. Typically, this program code is stored in the main memory of the computer system that is executing this code. However, it will be apparent to those skilled in the art that other memory means may be used for storing and executing the program instructions pertaining to the described mechanism and technique.

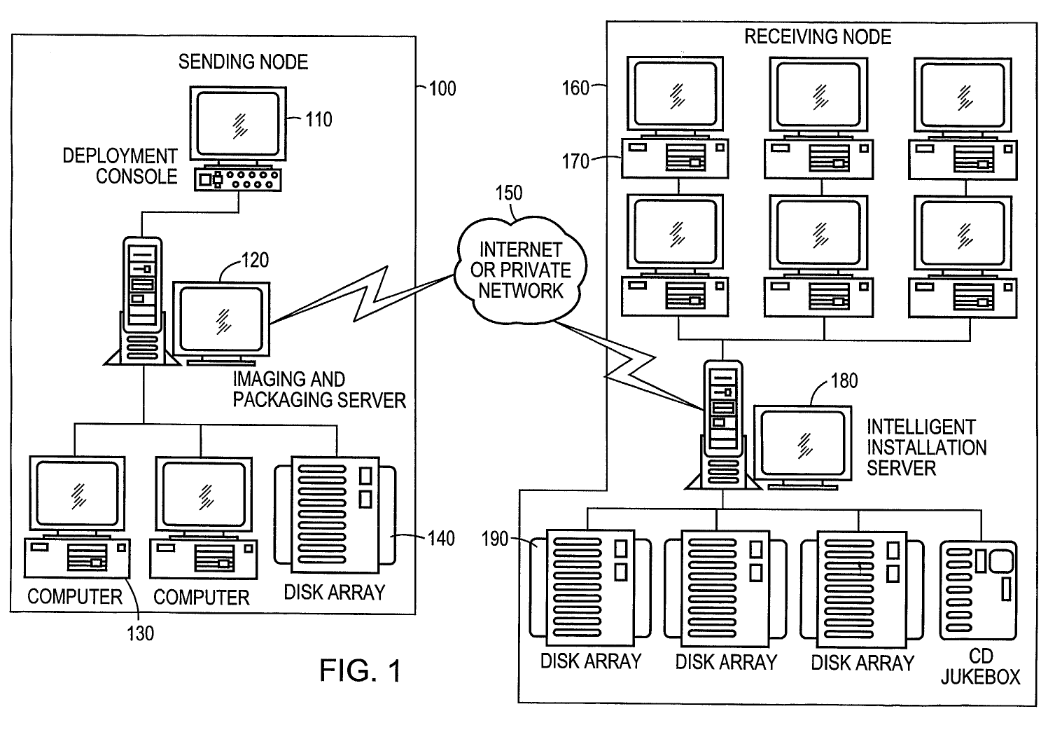

FIG. 1 is an overall block diagram of the preferred embodiment of the present invention comprising a Sending Node (SN) 100 that connects to a Receiving Node 160 through a network 150. The network 150 may comprise any form of communication medium including, but not limited to, point-to-point hardwired connections, wireless connections, and networked connections, among others.

The Sending Node comprises a deployment console 110, a source computer system 130, a storage subsystem 140, and an imaging and packaging server (IPS) 120. The Receiving Node comprises a plurality of target computer systems 170, an intelligent installation server (IIS) 180, and a storage subsystem 190.

The deployment console is a software interface that interfaces with the IPS. This software interface may be a Graphical User Interface (GUI), such as Win32, a web browser, or other form of interface. In the case of a GUI, the interface runs on a computer system and preferably connects over a network to the IPS using a socket interface. In the case of a browser, the browser runs on a computer system and preferably acts as a web client that connects over a network to a web server that is part of the IPS.

The source computer system may be any type of computer system, such as a workstation, a personal computer (PC), a server, or the like, that has associated with it a storage subsystem (not shown) on which software and data for use in the operation of the computer is stored. The storage subsystem of the source computer system is comprised of disks, tapes or other media that is used for storing information, locally. The source computer preferably has network connectivity to the IPS.

The software system of the source computer comprises all the executable and data files that are installed on the source computer's storage subsystem. These executable and data files include, but are not limited to, those files that comprise the operating system, applications, and files that have been created by the operating system, by the applications and by users.

The source computer runs an imaging client. The imaging client is a software application that runs as a process on the source computer. The imaging client handles the communication between the source computer and the IPS.

The IPS is a server computer system that acts as the central controlling point at the Sending Node. It preferably has network connectivity to the deployment console, the source computer, and the storage subsystem and the Receiving Node. The IPS performs such functions as interfacing with the deployment console, creating an image of the source computer system, handling the communications between the Sending Node component and the Receiving Node component, and interfacing with the storage subsystem of the Sending Node component.

The storage subsystem 140 of the Sending Node component is a data storage system that enables the IPS to save and retrieve data. The storage subsystem may consist of, though is not limited to, local disk storage or a storage engine coupled to a disk storage network.

At the Receiving Node, the target computer systems are those systems that, if selected, are to receive a copy of the source computer's software system. A target computer system may be a PC or any other computer system, such as a workstation or a server, that is hardware compatible with the source computer system. The target computer systems preferably have network connectivity to the IIS.

Each target computer is configured to run a thin-kernel rather than a regular operating system. The thin-kernel is a software application that handles the installation of the source computer's software system on the target computer. The thin-kernel, among other things, initializes and partitions the drives on the target computer, handles communication between the target computer and IIS during the installation process, modifies various system startup files, modifies the boot record to boot the new operating system, and reboots the target system.

The intelligent installation server (IIS) is the central controlling point at the Receiving Node. It preferably has network connectivity to the IPS, the target computer system and the storage subsystem at the Receiving Node. The IIS communicates with both the IPS and the target computer systems. The IIS is primarily responsible for creating an imaging area and packaging the imaging area along with script files and sending this package to the target computer systems for installation on those systems.

The storage subsystem 190 of the Receiving Node is a data storage system that provides data storage and retrieval capabilities to the IIS. This data storage subsystem preferably consists of, though is not limited to, local disk storage or a storage engine coupled to a disk storage network.

The overall duplication process can be broken down into four main steps. First, an image of the software system on the source computer system is created and stored at the Sending Node. Second, the user selects the target computer systems that are to receive a copy of the source computer system's software system. Third, each installation engine associated with each target computer system receives a copy of the source computer's software image and recreates the software system at the installation engine. Fourth, each installation engine directs each selected target system associated with the installation engine to install the recreated software system.

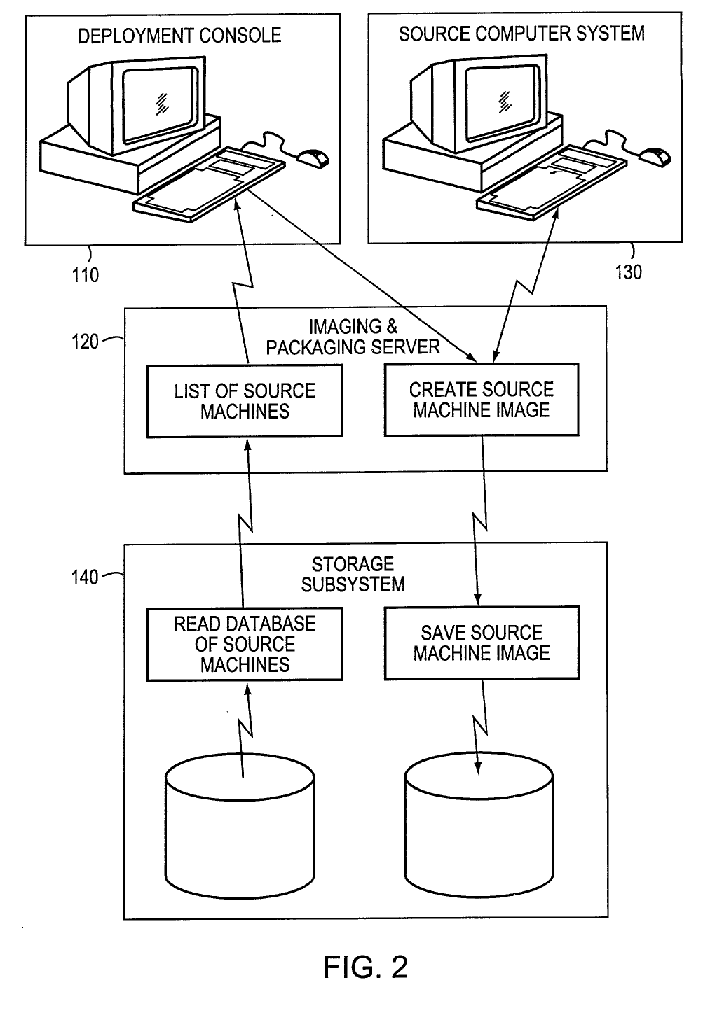

FIG. 2 illustrates in further detail the process of creating an image of the source computer. An image preferably consists of the hardware configuration and the operating-system-specific configuration information of the source computer system, as well as a list of all the files on the source computer system's storage subsystem.

From the deployment console 110 the user begins the image creation process by logging into the imaging and packaging server (IPS) 120 and requesting a list of source computer systems. The IPS processes this request by retrieving from a database all of the records for the source computer systems that are known to the IPS. In one embodiment of the invention the database resides on the storage subsystem 140. The IPS then compiles a list of source computers from the information stored in these records and sends this list to the deployment console for display.

Information that is stored in the record associated with the source computer includes, but is not limited to, the hostname of the source computer and the network address, such as IP address, of the source computer. In one embodiment of the invention, the database is created by manually entering the record information for each source computer into the database.

At the deployment console, the user then selects a source computer whose image is to be created from the list of source computers that are displayed. This selection is communicated to the IPS. Using the record information for the selected source computer the IPS establishes a network connection to the imaging client on the source computer system 130.

The IPS requests from the imaging client information about the source computer system's disk subsystem, as well as the hardware configuration and the operating-system-specific configuration of the source computer system.

The imaging client processes this request by compiling a list of all files that are installed on the source computer system, information about the disk partitions on the source computer's storage subsystem, a list of all the hardware attached to the computer system, and a list of operating-system-specific configuration information.

The information about the source computer system's disk subsystem preferably consists of a list of all the files that are installed on the source computer system, as well as disk partition information. For each file, the list desirably includes the full file name of the file and file attribute information associated with the file. The full file name desirably includes, but is not limited to, the full path name of the file including the names of any directories and subdirectories under which the file resides, as well as the file's name and any file name extensions. The file attribute information associated with the file desirably includes, but is not limited to, such information as the size of the file, file version, ownership, last modified date and protection attributes such as read, write and execute access.

The disk partition information desirably includes, but is not limited to, the name of the partition, the type of file system associated with the partition, the name of the disk drive associated with the partition, the name of the mount point associated with the partition, the device name associated with the partition, as well as the size of the partition.

The list of hardware desirably includes the entire hardware configuration of the source computer system. The list includes, but is not limited to, such information as the type of processor, the number of processors, the size of main memory, the number and types of disks and their sizes, and the types and versions of I/O cards that are installed in the system, among other information.

The operating-system-specific configuration information desirably includes information that is specific to the operating system that is installed on the source computer system. For example, if the Microsoft Windows operating system is installed on the source computer system, the Microsoft Windows Registry would desirably be included in the operating-system-specific configuration information. Likewise, if Linux was installed on the source computer, the configuration, packaging and device files would desirably be included in the operating-system-configuration information.

Once the source computer system gathers this information it supplies it to the IPS. The IPS then stores this information in a database located on the storage subsystem 140.

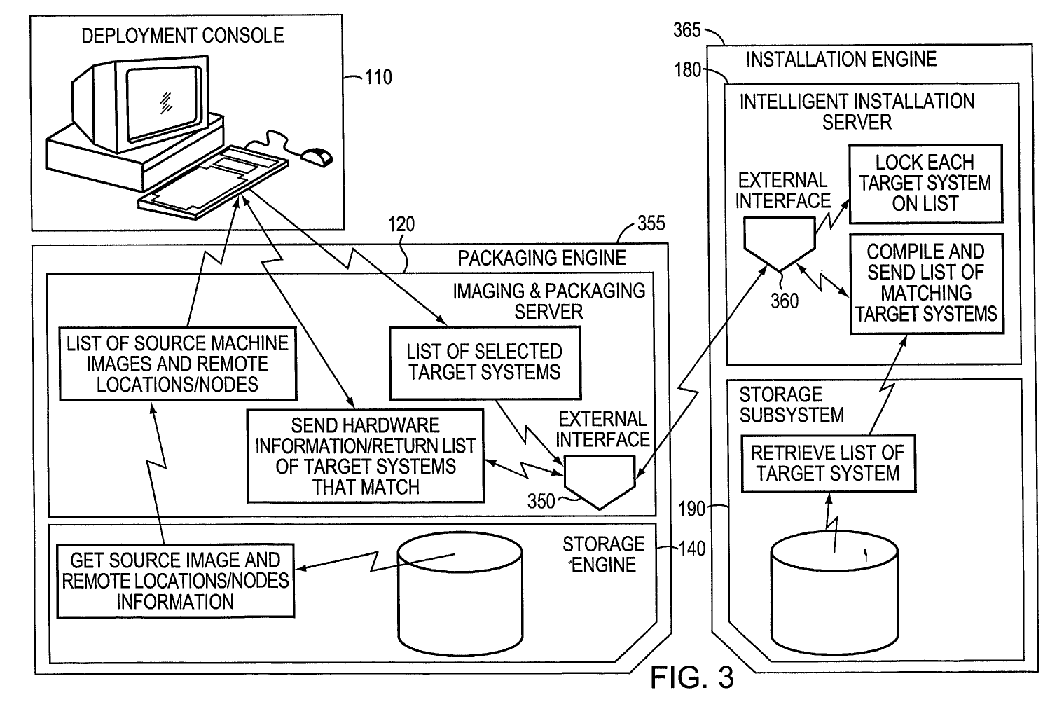

Once an image has been created, a user can deploy this image to an installation engine so that the software system that the image represents can be copied to any number of target computer systems that are qualified to receive the software system. FIG. 3 illustrates in further detail the process of selecting the target computer systems that are to receive a copy of the source computer's software system.

In FIG. 3, from the deployment console 110 the user requests from the IPS 120 a list of all the images in the image database and a list of all installation engines known to the IPS. The installation engines known to the IPS are maintained in a database that is accessible to the IPS. The information stored in the database that is associated with a particular installation engine includes, but is not limited to, the hostname and the network address, such as IP address, of the intelligent installation server at the installation engine. In one embodiment of the invention, the database is created by manually entering the information for each installation engine into the database.

The IPS retrieves the information for all the source images and installation engines. This information is processed and sent to the deployment console for display. At the deployment console, the user selects an image to deploy and one or more installation engines that are to receive the deployed image. These selections are conveyed to the IPS.

For each installation engine selected by the user, the following is performed:

1. The IPS establishes a two-way communications connection through an external interface 350 to an external interface 360 of the intelligent installation server (IIS) 180 at the installation engine 365. In the preferred embodiment of the invention, an external interface is a socket interface that is capable of establishing a TCP/IP connection to another remote socket. A person skilled in the art, however, would appreciate that the external interface could be any other two-way communications mechanism known in the art that allows a software process on a computer system to communicate with another software process, either on the same system or on a remote computer system.

2. The IPS sends to the IIS, the hardware configuration of the selected image, along with a request for a list of all available target computer systems known to the IIS whose hardware configuration is compatible with the hardware configuration of the selected image.

3. The IIS processes this request by first retrieving all of the records for the target computer systems that are known to the IIS from a database located on the storage subsystem 190. Each record contains among other information, the hardware configuration of the target computer system associated with the record. In one embodiment of the invention, the database is created by manually entering the information for each of the target computer systems.

4. Next, the IIS compiles a list of target computers that are available and whose hardware configuration is compatible with the hardware configuration sent by the IPS.

5. The list of all available hardware compatible target computer systems associated with the installation engine is then sent by the IIS to the IPS.

A target computer system is considered available if it is not in the process of installing software from an imaging area. The IIS determines that a target computer system is compatible by comparing certain components that make up the hardware configuration of the source computer to the equivalent components on the target computer. If the compared components are equal, the target computer is said to be compatible to the source computer. The components on the source computer that are compared to the equivalent components on the target computer include, but are not limited to, the central processor type, the type of hard disks, the type hard disk controllers and all other peripheral devices and their controllers that are attached to the source computer.

After the IPS receives a list of available target systems from each of the installation engines, the IPS places this information into a message and sends this message to the deployment console for display. The user then selects one or more of the target computer systems and sends this selection information to the IPS. For each IIS associated with the selected target computers, the IPS sends to the IIS a list of all the selected target computers associated with that IIS.

For each target computer system in the list, the IIS sets a lock associated with the target computer to indicate the IIS is in the process of installing an image on that target computer. Once all the target computer systems in the list have been locked, the IIS notifies the IPS that it has finished locking all the selected target computer systems. The IPS sends a message to the deployment console indicating the selected target computer systems that have been locked.

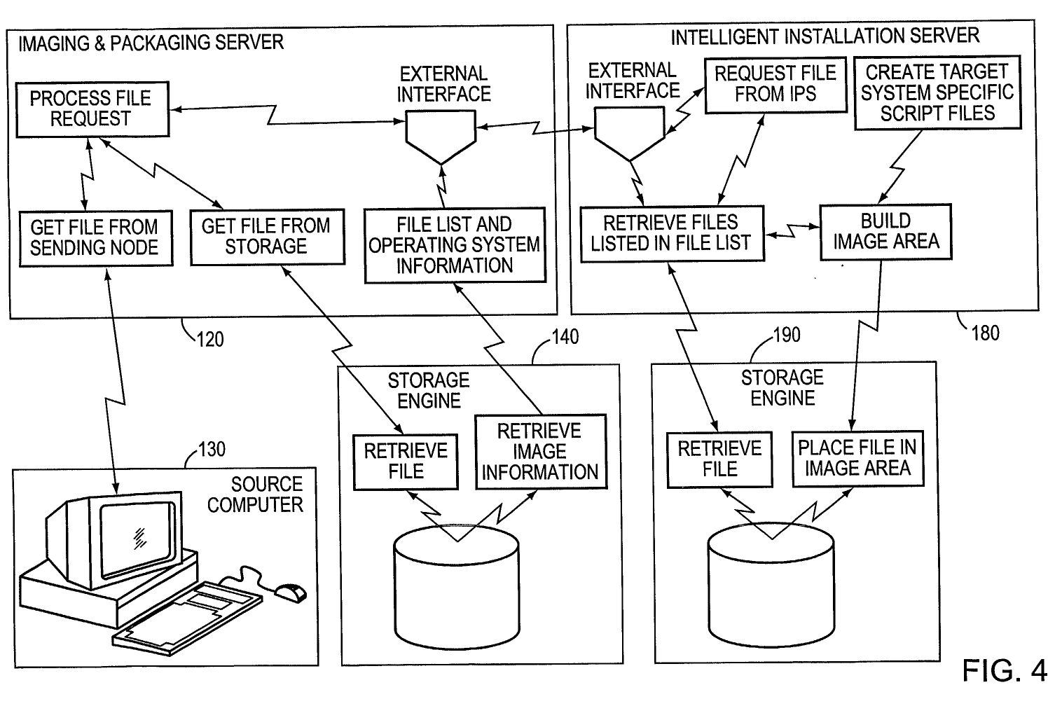

FIG. 4 illustrates in further detail the process of building an image area at the installation engine based on the image information of the source computer's software system.

The IPS 120, retrieves the operating system configuration information, the disk partitioning information and the file list associated with the image that was selected by the user from the storage subsystem 140. The IPS sends this information to the IIS 180 over a socket connection established to the IIS. In one embodiment of the invention, the information is compressed and encrypted before it is sent to the IIS.

The IIS receives the information sent by the IPS. In one embodiment of the invention, the information is received in a compressed and encrypted form and the IPS decrypts and decompresses the information before using it.

Using the disk partitioning information, the IIS initializes an imaging area on its storage subsystem 190. The imaging area is initialized in such a manner that it reflects the partitions that are described by the partitioning information.

Using the file list information, for every file listed in the file list, the IIS first determines where it can get a copy of the file. This determination is made by the IIS by searching its own storage subsystem for an exact copy of the file to determine if the file exists on its own storage subsystem. If the file does not exist on its own storage subsystem, the IIS requests a copy of the file from the IPS.

To determine if a copy of the file exists on its own storage system, the IIS uses the file name and various file attributes listed for the file in the file list. The IIS compares the file name and the file attribute information from the file list to the same information for a given file on its own storage subsystem. If the two match exactly, the file is said to exist on its own storage subsystem. The file attribute information that is compared may include but is not limited to, such information as the file size, file version, the last modified date and protection attributes such as read, write and execute access. A person skilled in the art would know that the file attribute information that is available and needs to be compared to determine if two files match exactly depends on the type of file system that was used to create the file.

Next, once the file is located, the IIS copies the file from its location to the imaging area on the storage subsystem 190. The IIS uses information from the file list to determine the file's location in the imaging area, as well as the file's name and attributes and so on.

Once all the files in the file list have been processed in this manner, script files necessary to configure the software in a manner that is specific to the target system are created. For example, if the target system is to run the IP protocol, a script file would be created to configure such network parameters for the IP protocol as the target computer's hostname, IP address, subnet mask, gateway address, DNS address and so on. The number of script files and the functions they perform are dependent on the software configuration of the source computer system.

In one embodiment of the invention, the script files are automatically created by the IIS. In this embodiment, the IIS examines the imaging area to determine what software needs to be configured. In addition, the IIS accesses a database on its storage engine 190 to gather specific details of the target computer system. The details of the target computer system may include but are not limited to, such information as the hardware configuration of the target system, it's IP address, subnet mask, gateway address and DNS address and other system specific information that is necessary to configure the software on the target system. In one embodiment of the invention, these details are manually entered into the database. Knowing the software that needs to be configured, as well as having the system specific information of the target computer necessary to configure the software, the IIS can determine which script files need to be created.

In another embodiment of the invention, some or all of the script files may be created on the IIS by a user. In this embodiment for those script files created by the user, the user logs into the IIS and creates the script files specifying the contents of each script file.

In other embodiments of the invention, a user may create some or all of the the script files on another computer system and place the user created script files on a remote computer system that preferably has network connectivity to the IIS. In this embodiment, the user creates the various script files, places these script files on the remote computer system, logs into the IIS and specifies the location of the script files to the IIS.

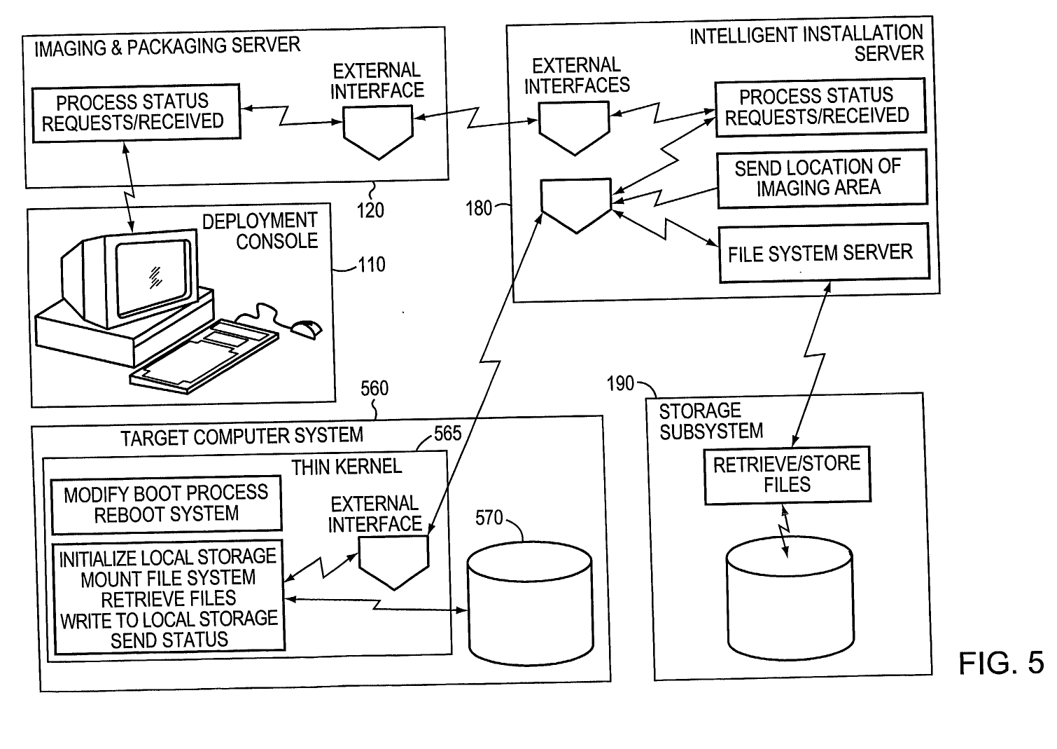

After the imaging area and the script files are created, the software system can be installed on each of the target computer systems. FIG. 5 illustrates in further detail the process of installing the software system on a target computer.

Referring to FIG. 5, the intelligent installation server (IIS) 180 establishes a connection to a thin-kernel 565 on the target computer system. The thin-kernel is a piece of software that is booted by the target computer system in place of an operating system. The thin-kernel, among other things, has the ability to establish a connection to the IIS, initialize the target computer's disk subsystem, decrypt and decompress files, copy files to the subsystem, control the boot process of the target computer and reboot the target computer. In one embodiment of the invention, the thin-kernel is a streamlined version of a Unix-based operating system.

The IIS establishes a two-way communications connection to the thin-kernel of the target computer and sends a message to the thin-kernel indicating that it has a software system that is to be installed on the target computer system. In one embodiment of the invention, the two-way communications connection is a connection between a socket interface on the IIS and a socket interface on the target computer. However, a person skilled in the art would appreciate that a two-way communications connection can be established using any well known two-way communication mechanisms known in the art that allow a software process on a computer system to communicate with another software process on a remote system.

Also included in the message sent to the thin-kernel is storage subsystem initialization information that the target computer system uses to determine how to initialize its storage subsystem to receive the software system stored in the imaging area. This information preferably includes but is not limited to, the number of disk partitions and the size and name of each disk partition. In one embodiment of the invention, this message also includes the location of the imaging area on the storage subsystem 190 where the software system resides.

Based on the information contained in the message, the thin-kernel initializes its local storage subsystem 570 to prepare to receive the files that make up the software system in the imaging area. This initialization includes using the disk partition information sent in the message to create and format the necessary disk partitions on its local storage subsystem 570.

Once the target computer's local storage subsystem has been initialized, the target computer creates a copy of the imaging area in its own storage subsystem by acquiring a copy of the files that make up the imaging area and placing these files into the appropriate area on its local storage subsystem.

In one embodiment of the invention, the File Transfer Protocol (FTP) utility is used to transfer a copy of the data stored in the imaging area to the target computer. In this embodiment, the thin-kernel on the target computer runs an FTP server process. The installation engine runs an FTP client process.

In this embodiment, for each target computer the following is performed:

1. The installation engine compresses and archives the entire imaging area and any script files that are to be run by target computer into one file.

2. The FTP client process on the installation engine connects to the FTP server process of the thin-kernel and transfers the compressed and archived file to the target computer.

3. After the file has transferred, the FTP connection is dropped and the thin-kernel decompresses and unarchives the file.

Well known techniques exist that enable a person skilled in the art to compress and archive a directory structure in such a manner as to preserve the directory structure containing all directories, subdirectories and files in that directory structure into a single file. Likewise, well known techniques exist that enable a person skilled in the art to decompress and unarchive a file in such a manner as to recreate the original directory structure containing all the files of the directory structure that was archived in the file.

In another embodiment of the invention, the thin-kernel remotely mounts the file systems where the imaging area and the script files reside on the IIS and copies the script files and the files from imaging area from the remotely mounted file system to its storage subsystem in such a manner as to preserve the directory structure that is reflected in the imaging area. Remote mounting techniques are well known and understood by those skilled in the art.

While the thin-kernel is initializing the disk subsystem or is in the process of copying files, status information, indicating the progress of the overall process, is displayed at the deployment console 110. This status information is sent from the thin-kernel to the IIS over a communication connection to the imaging and packaging server (IPS) 120. The IPS sends the information to the deployment console for display on the deployment console.

After the imaging area and script files have been copied, the thin-kernel modifies the system startup files so that various script files are run when the system is rebooted. Examples of the script files that should be run when the system is rebooted include those script files that set up the various system and network parameters such as the hostname, network address (e.g., IP address), gateway addresses, software registry entries and so on.

After the system startup files have been modified, the thin-kernel then modifies the boot record of the target computer's boot disk to boot the operating system that is now installed on target computer's storage subsystem. The thin-kernel then reboots the target computer system.

Once the target computer has rebooted and configured the newly installed software, it notifies the IIS that it has completed the installation. The IIS then clears the lock on the target computer system and informs the IPS that the target computer has completed the installation process. The IPS in turn sends this information to the deployment console for display.

In summary, the present invention enables a useful mechanism for duplicating the software system of a source computer onto a plurality of target computer systems. The present invention enables an image of a source computer to be transmitted to an installation engine. Using the transmitted image, the installation engine recreates the software system of the source computer. The installation engine then directs each selected target computer to install the recreated software system on the given target computer. One benefit of the present invention is that it enables the duplication of a software system onto a number of target computer systems without having to manually install each piece of software that comprises the software system on each target computer system.

The foregoing description has been directed to a specific embodiment of this invention. It will be apparent, however, that variations and modifications may be made to the described embodiment, with the attainment of some or all of their advantages. For example, in the described embodiment the packaging engine and the installation engine are described in terms such that they reside on separate computer systems; however this is not a requirement of the invention. It is possible to implement the functionality performed by the installation engine and packaging engine in such a manner that both engines reside and execute on the same computer system.

Therefore, it is the object of the appended claims to cover all of such variations and modifications as come within the true spirit and scope of the invention.

What is claimed is:

1. A computer-based method for duplicating, onto one or more selected target computers, a software system installed on a source computer the method comprising:
retrieving an image of the source computer, the image containing at least hardware configuration information of the source computer, disk partitioning information of the source computer, a list of files installed on the source computer and operating-system-specific information of the source computer;
transmitting the image from the source computer to an installation engine;
recreating at the installation engine in an imaging area the software system of the source computer system based on information in the image; and
installing the recreated software system on the selected target computer systems.

2. A computer readable medium having computer executable instructions for performing the method recited in claim 1.

3. The method of claim 1 wherein the list of files identifies at least for each file:
the full file name of the file; and
file attribute information associated with the file.

4. The method of claim 1 wherein the step of retrieving an image of the source computer further comprises retrieving the image from a database.

5. The method of claim 1 further comprising the step of reporting the status of the each target computer's installation of the recreated software system.

6. The method of claim 1 further comprising the step of determining hardware compatibility of the target computer with the source computer by comparing at the installation engine the hardware configuration information identified in the image to the hardware configuration of the target machine.

7. The method of claim 1 wherein the image is transmitted to the installation engine in a compressed and encrypted form.

8. The method of claim 1 wherein the step of recreating of the software system of the source computer further comprises:
initializing the imaging area based on the disk partition information;
for each file listed in the list of files, acquiring a copy of the file and writing the copy of the file to the imaging area; and
copying operating-system-specific information of the source computer to the imaging area.

9. The method of claim 8 wherein the step of acquiring a copy of the file further comprises:
if the file exists on the storage subsystem of the installation engine, retrieving the file from the storage subsystem at the installation engine; and
if the file does not exist on the storage subsystem of the installation engine requesting a copy of the file from the packaging engine.

10. The method of claim 1 wherein the step of installing the recreated software system on the selected target computer systems for each target computer further comprises:
at the installation engine, creating script files and storing the script files on the installation engine's storage system;
creating a communications connection between the installation engine and a thin-kernel on the target computer;
at the installation engine, sending a message to the thin-kernel the message containing storage subsystem initialization information;
at the target computer, initializing the local storage subsystem of the target computer based on the storage subsystem initialization information; and
at the target computer, copying the script files and the files of the imaging area to the local storage subsystem on the target computer.

11. The method of claim 10 wherein the step of copying script files and the files of the imaging area to the local storage subsystem on the target computer further comprises:
compressing and archiving the script files and the imaging area into a file at the installation engine;
transferring the file from the installation engine to the target computer; and
decompressing and unarchiving the file at the target computer.

12. The method of claim 10 wherein the subsystem initialization information identifies at least:
the number of disk partitions;
the name of each disk partition; and
the size of each disk partition.

13. The method of claim 10 wherein the message further identifies the location of the imaging area and the script files.

14. The method of claim 13 wherein the step of copying the files of the imaging area to the local storage subsystem on the target computer further comprises:
using the identity of the location of the imaging area, remotely mounting the file systems where the imaging area and script files reside; and
copying the script files and the files from the imaging area to the local storage subsystem on the target computer.

15. The method of claim 10 wherein the step of creating the script files further comprises:
examining the imaging area to determine the software to be configured;
reading details of the target computer system from a database; and
creating the script file based on the software to be configured and the details of the target computer system.

16. The method of claim 10 wherein the step of creating the script files further comprises:
a user logging into the installation engine's intelligent installation server;
the user specifying the contents of the script file; and
creating the script file based on the contents.

17. The method of claim 10 wherein the step of creating the script files further comprises:
a user specifying the contents of the script file and placing the contents of the file on a remote system;
the user logging into the installation engine's intelligent installation server and specifying the location of the file on the remote system; and
creating the script file by copying the file on the remote system to the installation engine's storage subsystem.

18. The method of claim 10 further comprising after the step of copying the script files:
at the target computer, rebooting the target computer; and
at the target computer, sending a message to the installation engine.

19. A computer-based system for duplicating a software system installed on a source computer onto a plurality of target computers comprising:
a deployment console;
an imaging and packaging server;
a source computer system;
an intelligent installation server;
a plurality of target computers;
a communications connection between the deployment console and the imaging and packaging server;
a communications between the imaging and packaging server and the source computer system;
a communications connection between the imaging and packaging server and the intelligent installation server;
a communications connection between the intelligent installation server and the plurality of target computers;
a means for selecting the source computer system from a plurality of source computer systems at the deployment console;
a means for creating and storing an image of a software system installed on the selected source computer at the imaging and packing server;
a means for transmitting the image from the imaging and packaging server to the intelligent installation server;
a means for selecting the plurality of target systems at the deployment console;
a means for recreating the software system of the source computer from information provided by the image at the intelligent installation server; and
a means for installing the recreated image on the selected plurality of target computer systems.

20. A computer-based method for creating an image of a first computer and saving the image on a second computer system the method comprising:
at the first computer, creating an image of the first computer, the image identifying at least the hardware configuration of the first computer, a list of files installed on the first computer and operating-system-specific information of the first computer;
sending the image to the second computer; and
at the second computer, storing the image in a database that is accessible by the second computer.

21. A computer readable medium having computer executable instructions for performing the method recited in claim 20.

22. The method of claim 20 wherein the list of files identifies at least for each file:
the full name of the file; and
file attribute information associated with the file.

23. The method of claim 20 further comprising the step of selecting the first computer system from a plurality of computer systems.

24. A computer-based method for recreating the software system of a source computer onto an installation engine the method comprising:
retrieving an image of the source computer from a database, the image containing a list of files that are installed on the source computer and disk partitioning information of the source computer;
initializing an imaging area located on the installation engine's storage subsystem using the disk partitioning information;
acquiring a copy of each file that is listed in the list of files; and
storing the retrieved files in the imaging area.

25. A computer readable medium having computer executable instructions for performing the method recited in claim 24.

26. The method of claim 24 wherein the list of files identifies at least for each file:
the full file name of the file; and
file attribute information associated with the file.

27. The method of claim 24 wherein the step of acquiring a copy of each file further comprises:
if the file exists on the storage subsystem of the installation engine, retrieving the file from the storage subsystem at the installation engine; and
if the file does not exist on the storage subsystem of the installation engine requesting a copy of the file from the packaging engine.
